(19) United States
(12) Patent Application Publication
(10) Pub. No.: US 2024/0118695 A1
(43) Pub. Date: Apr. 11, 2024

(54) NAVIGATION OF BOAT USING DRONE SUPPORT

(71) Applicant: Honda Motor Co., Ltd., Tokyo (JP)

(72) Inventors: Ryuta SUZUKI, Saitama (JP); Takashi HASHIZUME, Saitama (JP)

(73) Assignee: Honda Motor Co., Ltd., Tokyo (JP)

(21) Appl. No.: 17/961,562

(22) Filed: Oct. 7, 2022

(51) Int. Cl. G05D 1/00; B64C 39/02; G05D 1/10

(52) U.S. Cl. CPC G05D 1/0094; B64C 39/024; G05D 1/0038; G05D 1/106; B64C 2201/042; B64C 2201/066; B64C 2201/127; B64C 2201/146

(57) ABSTRACT

A terminal device, adapted to control a drone to support navigation of a boat, the terminal device including a control unit and a display unit. The control unit including a processor, configured to obtain a speed of the boat, and receive an image that is imaged by the drone. The display unit including a display for displaying the image that is imaged by the drone, wherein the terminal device is configured to control an altitude of the drone based on the speed of the boat.

### BACKGROUND OF THE DISCLOSURE

### Technical Field

The disclosure relates to navigation of a boat, and more specifically relates to navigation of the boat using a drone for support.

### Related Art

When a boat is navigated, it is challenging task to identify obstacles in a surrounding area of the boat. Therefore, skill and careful navigation by a captain is needed which takes focus and time. Accordingly, navigation of the boat may be stressful to the captain.

Conventionally, a plurality of cameras may be attached to the boat to create a surrounding view image of the boat or a bird's eye view image of the boat by synthesizing the images obtained from the plurality of cameras. This method requires the plurality of cameras, and requires synthesizing of the images. Since the plurality of cameras are fixed to the boat, there may be an issue that a field of view for each of the plurality of cameras is fixed. Therefore, the field of view for each of the plurality of cameras is determined by a location where the camera is installed. That is to say, there is no flexibility to change the field of view of the cameras according to a control state of the boat and/or a user's requirements.

Therefore, a way for flexibly changing the field of view of the image based on the control state of the boat and/or the user's requirements is needed.

### SUMMARY

According to an embodiment of the disclosure, a terminal device, adapted to control a drone to support navigation of a boat is provided. The terminal device includes a control unit and a display unit. The control unit including a processor, configured to obtain a speed of the boat, and receive an image that is imaged by the drone. The display unit including a display for displaying the image that is imaged by the drone, wherein the terminal device is configured to control an altitude of the drone based on the speed of the boat.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures.

FIG. 1 is a schematic diagram illustrating a navigation of a boat using a drone for support according to an embodiment of the disclosure.

FIG. 2 is a schematic diagram illustrating a terminal device controlling a flight altitude of a drone based on a first speed of a boat according to an embodiment of the disclosure;

FIG. 3 is a schematic diagram illustrating a terminal device controlling a flight altitude of a drone based on a second speed of a boat according to an embodiment of the disclosure;

FIG. 4 is a schematic diagram illustrating a control unit controlling a drone to move in a new steering angle of a boat according to an embodiment of the disclosure;

FIG. 5 is a schematic flow chart illustrating a navigation of a boat using a drone for support according to an embodiment of the disclosure;

### DESCRIPTION OF THE EMBODIMENTS

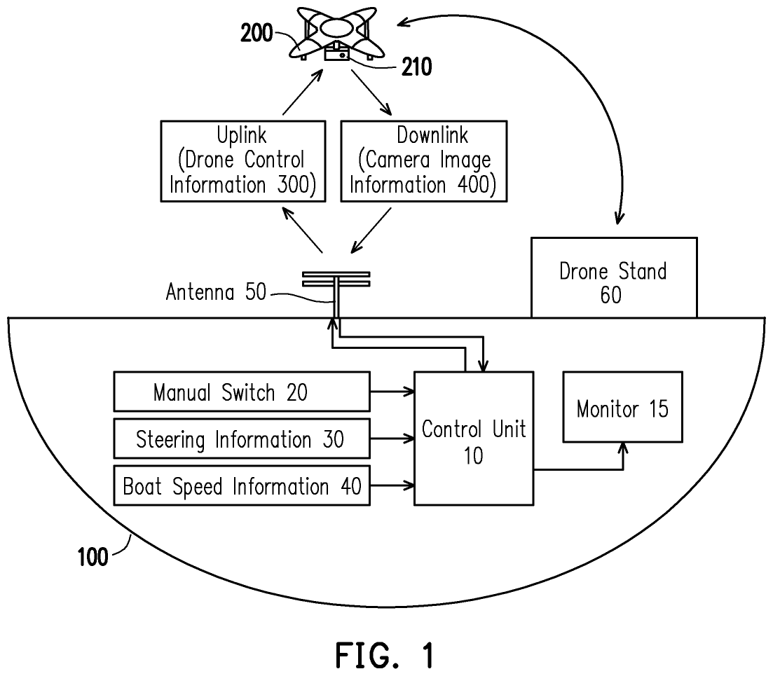

FIG. 1 is a schematic diagram illustrating a navigation of a boat using a drone for support according to an embodiment of the disclosure. Referring to FIG. 1, a boat 100 and a drone 200 are provided. The boat 100 may be, for example, a water vessel, a water craft, a ship and/or the like. The boat 100 includes a propulsion system, for example, a motor for propelling the boat 100 in water. The motor may be, for example, an inboard motor, an outboard motor, a partially inboard-partially outboard motor and the like. A propeller is coupled to an output shaft of the motor. The boat 100 includes a steering system, for example, a steering wheel coupled to a rudder to steer a direction of the boat 100. The steering wheel may be coupled to the rudder by, for example, a cable or a wire or the like. The boat 100 may include a manual driving mode and an automatic driving mode.

Referring to FIG. 1, a control unit 10 and an antenna 50 are disposed on the boat 100. The control unit 10 is an example of a terminal device. The control unit 10 includes, for example, a processor and a memory. The control unit 10 is adapted to control the drone 200. More specifically, the control unit 10 is adapted to control the drone 200 to support navigation of the boat 100. In more detail, the control unit 10 is coupled to the antenna 50. The control unit 10 may be coupled to the antenna 50 by, for example, a cable or a wiring. The control unit 10 sends a drone control information 300 to the drone 200 via the antenna 50. The drone control information 300 may be transmitted to the drone 200 by a wireless communication signal. The drone control information 300 includes commands for controlling the drone 200.

The drone 200 includes a camera 210. The camera 210 includes, for example, an image sensor sensing an image. In addition, the drone 200 includes a transmitter and a receiver. The receiver disposed on the drone 200 is configured to receive the drone control information 300 transmitted from the control unit 10. The transmitter disposed on the drone 200 is configured to send a camera image information 400 to the control unit 10. The camera image information 400 may be transmitted to the control unit 10 by a wireless communication signal. The camera image information 400 includes data, for example, a photograph or a video recorded by the camera 210. The camera image information 400 is an example of an image that is imaged by the drone 200. The photograph or the video may be recorded by the camera 210 and transmitted in real time to the control unit 10. In addition, the photograph or the video may be recorded by the camera 210 and stored in a memory disposed on the drone 200, wherein the stored the photograph or the stored video may be transmitted to the control unit 10 at a later time. The drone control information 300 may further include GPS coordinates of the boat 100 such that the drone 200 may track the boat 100 with the camera 210.

Referring to FIG. 1, a monitor 15 may be disposed on the boat 10. The monitor 15 is an example of a display unit. The monitor 15 includes a display for displaying the image that is imaged by the drone 200. More specifically, the control unit 10 is configured to receive the image that is imaged by the drone 200. The control unit 10 displays the image on the monitor 15. In the present embodiment, the control unit 10 displays the image that is imaged in real time by the drone 200 on the monitor 15.

Referring to FIG. 1, the control unit 10 receives a boat speed information 40 as an input. The boat speed information 40 includes information regarding a speed of the boat 100. A speed of the boat 100 may be measured by, for example, a speedometer, a global positioning system (GPS), and/or the like. The speedometer may include, for example, a pressure gauge and a pitot tube for estimating the speed of the boat 100. The GPS is an example of a Global Navigation Satellite System (GNSS). The control unit 10 may obtain the speed of the boat 100 via, for example, the speedometer and/or the GPS. In another example, control unit 10 may obtain the speed of the boat 100 via, for example, a rate of rotation (such as an rpm) of the engine/motor or the propeller.

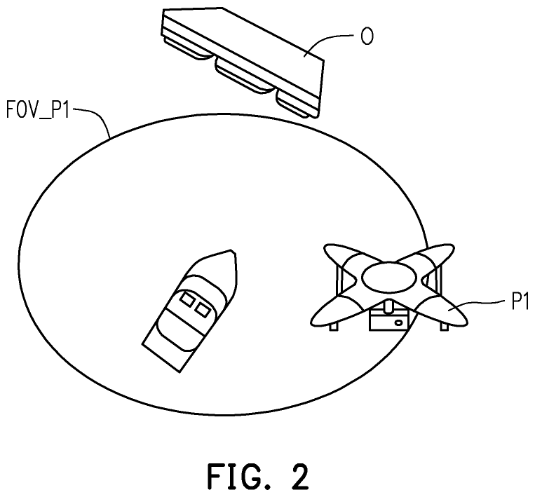

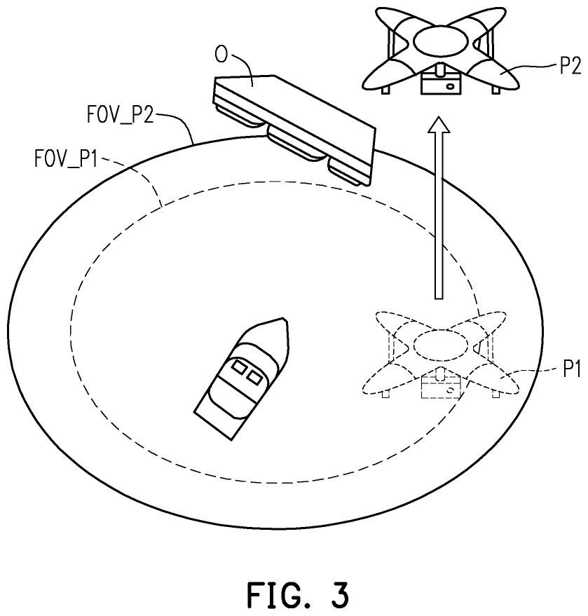

FIG. 2 is a schematic diagram illustrating a terminal device controlling a flight altitude of a drone based on a first speed of a boat according to an embodiment of the disclosure. FIG. 3 is a schematic diagram illustrating a terminal device controlling a flight altitude of a drone based on a second speed of a boat according to an embodiment of the disclosure. Referring to FIG. 2 and FIG. 3, a first speed of the boat 100 in FIG. 2 is less than a second speed of the boat 100 in FIG. 3. The first speed of the boat 100 in FIG. 2 may be, for example, travelling at the speed of 20 kph (kilo meters per hour). The second speed of the boat 100 in FIG. 3 may be, for example, travelling at the speed of 30 kph. The speed of the boat 100 are described as examples only and are not intended to limit the disclosure.

Referring to FIG. 2 and FIG. 3, the control unit 10 is configured to control a flight altitude of the drone 200 based on the speed of the boat 100 that is obtained. More specifically, the control unit 10 is configured to automatically control the flight altitude of the drone 200 based on the speed of the boat 100 that is obtained. That is to say, the control unit 10 automatically controls the flight altitude of the drone 200 via a control algorithm, and a user is not controlling the flight altitude of the drone 200 based on the speed of the boat 100. For example, the control unit 10 is configured to automatically control the flight altitude of the drone 200 such that the flight altitude of the drone 200 increases when the control unit 10 detects the speed of the boat 100 increases. In another example, the control unit 10 is configured to automatically control the flight altitude of the drone 200 such that the flight altitude of the drone 200 decreases when the control unit 10 detects the speed of the boat 100 decreases. In another embodiment of the disclosure, the user may control the flight altitude of the drone 200.

Referring to FIG. 2, for example, when the speed of the boat 100 is travelling at the speed of 20 kph, the control unit 10 may be configured to control the drone 200 to fly at a first flight altitude P1 of, for example, 30 meters. The camera 210 of the drone 200 flying at first flight altitude P1 has a first field of view FOV_P1. The first field of view FOV_P1 is an example of the image that is imaged by the drone 200.

Referring to FIG. 3, for example, when the speed of the boat 100 is travelling at the speed of 30 kph, the control unit 10 may be configured to control the drone 200 to fly at a second flight altitude P2 of, for example, 50 meters. The camera 210 of the drone 200 flying at the second flight altitude P1 has a second field of view FOV_P2. The second field of view FOV_P2 is an example of the image that is imaged by the drone 200.

In another example of the disclosure, for example, when the speed of the boat 100 is travelling at the speed of 40 kph, the control unit 10 may be configured to control the drone 200 to fly at a third flight altitude of, for example, 70 meters.

The second flight altitude P2 shown in FIG. 3 is at a higher altitude than the first flight altitude P1 shown in FIG. 2. Since the second flight altitude P2 is at the higher altitude than the first flight altitude P1, a second area of the second field of view FOV_P2 is greater than a first area of the first field of view FOV_P1. The second area of the second field of view FOV_P2 may be for example 1000 square meters. The first area of the first field of view FOV_P1 may be for example 700 square meters.

Similarly, the third flight altitude (for example, 70 meters) is at the higher altitude than the second flight altitude P2 (for example, 50 meters). Since the third flight altitude is at the higher altitude than the second flight altitude P3, a third area of the third field of view is greater than the second area of the second field of view FOV_P2. The third area of the third field of view may be for example 1300 square meters.

In this way, flexibly changing the field of view of the image based on the control state (for example, speed) of the boat 100 is achieved. When the speed of the boat 100 increases, the field of view of the image from the drone 200 increases, such that the user may have an expanded situational awareness of a surrounding of the boat 100. This may provide the user with additional reaction time for reacting to any obstacles in the surrounding area of the boat 100 even with increased boat speeds.

The control unit 10 is configured to automatically control the flight altitude of the drone 200 based on the speed of the boat 100 that is obtained. A relationship between the flight altitude of the drone and the speed of the boat 100 may be set according to requirements. For example, a graph showing the flight altitude of the drone 200 versus the speed of the boat 100 may be depicted by, a line having inclination, a line having a step, a curved line, any combination of the above and/or the like. In an embodiment of the disclosure, the relationship between the flight altitude of the drone 200 and the speed of the boat 100 is predetermined, and may be set by a user according to requirements.

It should be noted, in an embodiment of the disclosure, the control unit 10 may be configured to change a viewing angle of the camera 210 disposed on the drone 200 to a wider angle when the speed of the boat 100 increases. More specifically, the control unit 10 may be configured to change the viewing angle of the camera 210 to the wider angle by changing a focal length of a lens of the camera 210. By changing the viewing angle of the camera 210 to the wider angle, an area covered/imaged by the first field of view FOV_P1 may be increased even without increasing the flight altitude of the drone 200. In addition, by changing the viewing angle of the camera 210 to the wider angle, an area covered/imaged by the second field of view FOV_P1 may be increased even without increasing the flight altitude of the drone 200. In an embodiment of the disclosure, the control unit 10 may be configured to control the altitude of the drone 200 such that the altitude of the drone 200 increases when the speed of the boat 100 increases, only after the viewing angle of the camera 210 is at the maximum viewing angle,

Referring to FIG. 2 and FIG. 3, the control unit 10 is configured to control the drone 200 such that the image that is imaged by the drone 200 captures the boat 100 having the control unit 10 disposed thereon. For example, a transmitter that emits a signal may be disposed on the boat 100, and a sensor that detects the signal emitted from the transmitter may be disposed on the drone 200. The sensor disposed on the drone 200 may detect a direction of the signal emitted by the transmitter disposed on the boat 100. In another example, the boat 100 may send GPS coordinates of a position of the boat 100 to the drone 200, while the drone 200 may have a GPS disposed on the drone 200, wherein the drone 200 may detect the direction of the boat 100 based on the GPS location of the boat 100 and the GPS location of the drone 200. The above methods are described as examples only and are not intended to limit the disclosure. In this way, the drone 200 may detect the direction of the boat 100 relative to the drone 200, such that drone 200 may control the drone 200 and/or a pointing direction of the camera 210 of the drone 200 to capture the image that includes the boat 100.

Referring to FIG. 2 and FIG. 3, the first field of view FOV_P1 is an example of the image that is imaged by the drone 200. The second field of view FOV_P2 is an example of the image that is imaged by the drone 200. In the image that is imaged by the drone 200 (the first field of view FOV_P1 or the second field of view FOV_P2), a first area forward of a travelling direction of the boat 100 is greater than a second area rearward of the travelling direction of the boat 100. More specifically, the first area in front of the travelling direction of the boat 100 is greater than the second area in the rear of the travelling direction of the boat 100. In more detail, the control unit 10 is configured to control the drone 200 such that the camera 210 captures the boat 100 so that a front end of the boat 100 is closer to a center point of the image relative to a rear end of the boat 100. In other words the rear end of the boat 100 is further from the center point of the image relative to the front end of the boat 100. It should be noted, when the boat 100 is travelling in reverse, an area to the rear of the boat 100 is the first area and an area to the front of the boat 100 is the second area. That is to say, when the boat 100 is travelling in reverse, the control unit 10 is configured to control the drone 200 such that the camera 210 captures the boat 100 so that a rear end of the boat 100 is closer to a center point of the image relative to a front end of the boat 100. In other words, when the boat 100 is travelling in reverse, the front end of the boat 100 is further from the center point of the image relative to the rear end of the boat 100.

Referring to FIG. 1, the control unit 10 receives a steering information 30 as an input. The steering information 30 includes information regarding a steering direction of the boat 100. A steering direction of the boat 100 may be measured by, for example, an angle sensor, the global positioning system (GPS), and/or the like. The angle sensor may include, for example, a potentiometer for estimating a pointing direction of the steering wheel of the boat 100. The control unit 10 may obtain the steering direction of the boat 100 via, for example, the angle sensor and/or the GPS.

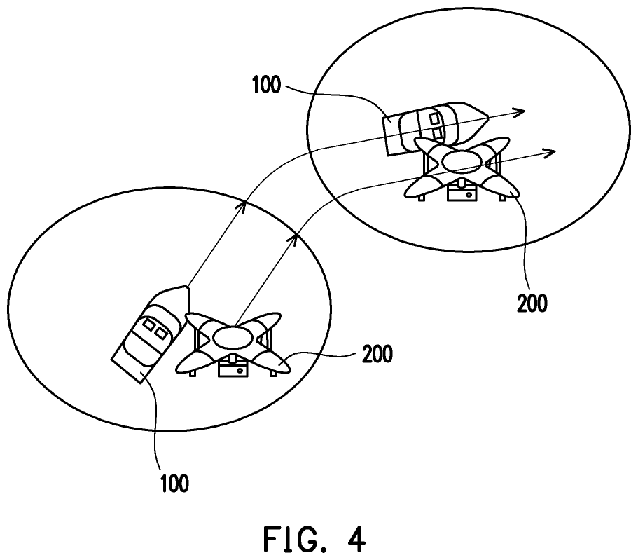

FIG. 4 is a schematic diagram illustrating a control unit controlling a drone to move in a new steering angle of a boat according to an embodiment of the disclosure. Referring to FIG. 4, the control unit 10 obtains the steering direction of the boat 100, and the control unit 10 is configured to control the drone 200 based on the steering direction of the boat 100. For example, when the control unit detects a change in the steering angle of the boat 100, the control unit 100 is configured to control the drone 200 to move in the new steering angle of the boat 100.

Referring to FIG. 1, a drone stand 60 is disposed on the boat 100. The drone stand 60 is an area for the drone 200 to land and/or recharge electricity. More specifically, a first battery of the drone 200 may be recharged at the drone stand 60 by a second battery disposed on the boat 100. That is to say, the drone stand 60 receives electricity to recharge the first battery of the drone 200 from the second battery disposed on the boat 100.

Referring to FIG. 1, a manual switch 20 is disposed on the boat 100. The manual switch 20 may be, for example, a physical push button, a touch button on an HMI (for example, the monitor 15 may be a capacitive touch screen) and the like. The manual switch 20 is an example of an input unit.

The control unit 10 receives a signal from the manual switch 20 as an input. When the control unit 10 receives an input signal from the manual switch 20, the control unit 10 sends a signal to the drone 200 to take off (lift off). In other words, when the control unit 10 receives an input signal from the manual switch 20, the drone 200 flies into the air such that navigation of the boat 100 using the drone 200 for support may be performed.

The control unit 10 is configured to set a flight mode of the drone 200. The flight mode includes, for example, a navigation mode and a docking mode. The flight altitude of the drone 200 is changed based on whether the flight mode is set to the navigation mode or the docking mode. Here, the flight mode of the drone 200 is set to correspond to the operation mode of the boat 100. For example, when the operation mode of the boat 100 is set to navigation mode by an operation of a user, the control unit 10 automatically sets the flight mode of the drone 200 to navigation mode. When the boat 100 is set to docking mode by an operation of a user, the control unit 10 automatically sets the flight mode of the drone 200 to docking mode. When in docking mode, the flight altitude of the drone 200 is controlled to a constant flight altitude regardless of a speed of the boat 100. When in navigation mode, the flight altitude of the drone 200 is controlled based on a speed of the boat 100.

More specifically, when the flight mode is set to the navigation mode, the control unit 10 is configured to control the flight altitude of the drone 20 based on the speed of the boat 100.

On the other hand, when the flight mode is set to docking mode, the control unit 10 is configured to control the flight altitude of the drone 200 to fly at a substantially constant flight altitude regardless of the speed of the boat 100. The substantially constant flight altitude of the docking mode is lower than the flight altitude of the navigation mode. The substantially constant flight altitude of the docking mode may be, for example, 20 meters above the boat. In another embodiment of the disclosure the flight altitude may be set, for example, at a predetermined distance above sea level.

In this way, flexibly changing the field of view of the image based on the user's requirements (for example, navigation mode or docking mode) is achieved.

Referring to FIG. 2 and FIG. 3, the control unit 10 may include a function, for example a software, that is capable of identifying/detecting objects in the image that is imaged by the drone 200. For example, the control unit 10 may detect the object O in the image that is imaged by the drone 200. The object O may be, for example, an object such as a pier, a jetty, a rock, another boat and/or the like. The object O is an example of an obstacle. Furthermore, the control unit 10 may process the image that is imaged by the drone 200 such that information about the obstacle (object) is displayed on the monitor 15. For example, the object O may be highlighted using a color, or an outline of the object O may be highlighted by the color. The color may be, for example, red, purple, orange and/or the like. In another example, an arrow may be superimposed on the image to point out the object O. The above are described as examples only and are not intended to limit the disclosure.

The control unit 10 may also detect the boat 100 in the image that is imaged by the drone 200.

In addition, the control unit 10 may include a function, for example a software, that is capable of identifying/detecting fish in the image that is imaged by the drone 200. Furthermore, the control unit 10 may process the image that is imaged by the drone 200 such that information about the fish (or school of fish) is displayed on the monitor 15. For example, the school of fish may be highlighted using a color, or an outline of the school of fish may be highlighted by the color. The color may be, for example, red, purple, orange and/or the like. In another example, an arrow may be superimposed on the image to point out the school of fish. The above are described as examples only and are not intended to limit the disclosure. In an embodiment of the disclosure, the drone 200 is an aerial drone. In another embodiment of the disclosure, the drone 200 may be an underwater drone.

In an embodiment of the disclosure, the monitor 15 may be configured to switch between the image that is imaged by the drone 200 and an image that is imaged by a camera disposed on the boat 100 based on the speed of the boat 100. In more detail, a plurality of cameras may be attached to the boat 100 to create, for example, a surrounding view image of the boat 100 or a bird's eye view image of the boat 100 by synthesizing the images obtained from the plurality of cameras. For example, when the speed of the boat 100 is travelling slower than 5 kph, the monitor 15 may be configured to display the synthesized image obtained from the plurality of cameras fixed on the boat 100, and when the speed of the boat 100 is travelling faster than 5 kph, the monitor 15 may be configured to display the image that is imaged by the drone 200.

In another embodiment of the disclosure, the monitor 15 may be configured to switch between the image that is imaged by the drone 200, the image that is imaged by the camera disposed on the boat 100, and a satellite image based on the speed of the boat 100. For example, when the speed of the boat 100 is greater than a predetermined speed of, for example, 50 kph, the monitor 15 may be configured to switch from the image that is imaged by the drone 200 to the satellite image.

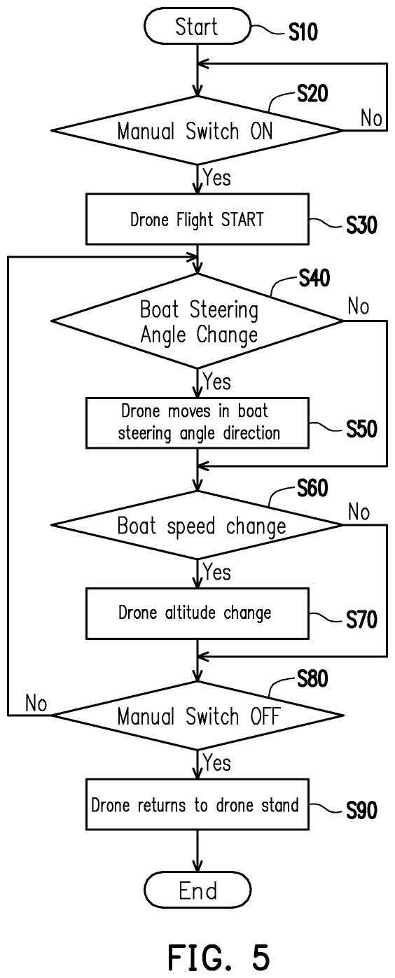

FIG. 5 is a schematic flow chart illustrating a navigation of a boat using a drone for support according to an embodiment of the disclosure. Referring to FIG. 5, in step S20, the control unit 10 detects whether a user has turned ON the manual switch 20. If yes, in step S30, drone flight is started and the drone 200 flies to a predetermined attitude specified by the control unit 10. In step S40, the control unit 10 detects a boat steering angle change. If yes, in step S50, the control unit 10 controls the drone 200 to move in the boat steering angle direction. Next, the control unit 10 detects if there is a boat speed change. If yes, the control unit 10 controls the flight altitude of the drone 200 based on the speed of the boat 100. When the control unit 10 detects the user has turned OFF the manual switch 20, the control unit 10 controls the drone 200 to return to the drone stand 60.

It should be noted, the above described speeds of the boat 100 are examples only and are not intended to limit the disclosure. In addition, the above described flight altitudes of the drone 200 are examples only and are not intended to limit the disclosure. The relationship between the speed of the boat 100 and the flight altitude of the drone 200 are not limited hereto and may be set according to user requirements.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A terminal device, adapted to control a drone to monitor a surrounding environment of a boat, the terminal device comprising:
a control unit, comprising a processor, configured to:
obtain a speed of the boat; and
receive an image that is imaged by the drone,
a display unit, comprising a display, for displaying the image that is imaged by the drone;
wherein the terminal device is configured to control an altitude of the drone based on the speed of the boat.

2. The terminal device according to claim 1, wherein the terminal device is disposed on the boat, and the terminal device is configured to control the drone such that the image that is imaged by the drone captures the boat having the terminal device.

3. The terminal device according to claim 2, wherein, in the image that is imaged by the drone, a first area forward of a travelling direction of the boat is greater than a second area rearward of the travelling direction of the boat.

4. The terminal device according to claim 1, wherein the control unit obtains a turning direction of the boat, and the terminal device is configured to control the drone based on the turning direction of the boat.

5. The terminal device according to claim 1, further comprising:
an input unit,
wherein the terminal device sends a signal to the drone to take off, when the control unit receives an input signal from the input unit.

6. The terminal device according to claim 1, wherein a battery of the drone is recharged at a drone stand disposed on the boat.

7. The terminal device according to claim 6, wherein the drone stand receives electricity to recharge the drone from a battery disposed on the boat.

8. The terminal device according to claim 1, wherein
the terminal device is configured to set a flight mode of the drone, the flight mode including a navigation mode and a docking mode,
the altitude of the drone is changed based on whether the flight mode is set to the navigation mode or the docking mode.

9. The terminal device according to claim 8, wherein when the flight mode is set to the navigation mode, the terminal device is configured to control the altitude of the drone based on the speed of the boat,
when the flight mode is set to docking mode, the terminal device is configured to control the altitude of the drone to fly at a substantially constant altitude regardless of the speed of the boat, the substantially constant altitude of the docking mode is lower than the altitude of the navigation mode.

10. The terminal device according to claim 1, wherein information about fish is displayed on the display unit.

11. The terminal device according to claim 1, wherein information about an obstacle is displayed on the display unit.

12. The terminal device according to claim 1, wherein the display unit is configured to switch between the image that is imaged by the drone and an image that is imaged by a camera disposed on the boat based on the speed of the boat.

13. The terminal device according to claim 12, wherein the display unit is configured to switch to a satellite image when the speed of the boat is greater than a predetermined speed.

14. The terminal device according to claim 1, wherein
the control unit is configured to control the altitude of the drone such that the altitude of the drone increases when the speed of the boat increases, and the altitude of the drone decreases when the speed of the boat decreases.

15. The terminal device according to claim 1, wherein
the control unit is configured to change a viewing angle of a camera disposed on the drone to a wider angle when the speed of the boat increases, and
after the viewing angle of the camera is changed to a maximum viewing angle, the control unit is configured to control the altitude of the drone such that the altitude of the drone increases when the speed of the boat increases.
